(19) United States
(12) Patent Application Publication
(10) Pub. No.: US 2026/0270668 A1
(43) Pub. Date: Sep. 10, 2026

(54) COMPUTE SERVER REGISTRATION WITH A COMPOSITION MANAGEMENT FUNCTION FOR COMPUTE OFFLOAD IN A WIRELESS NETWORK

(71) Applicant: MEDIATEK INC., Hsinchu City (TW)

(72) Inventors: Nathan Edward TENNY, San Jose, CA (US); Mehrdad SHARIAT, Cambridge (GB); Chia-Chun HSU, Hsinchu City (TW)

(21) Appl. No.: 19/166,218

(22) PCT Filed: Jun. 5, 2024
(86) PCT No.: PCT/CN2024/097466

§ 371 Date: Sep. 17, 2025

Related U.S. Application Data
(60) Provisional application No. 63/506,839, filed on Jun. 8, 2023.
(60) Provisional application No. 63/506,841, filed on Jun. 8, 2023.

(51) Int. Cl. H04W 4/50; H04W 60/00

(52) U.S. Cl. CPC H04W 4/50; H04W 60/00

(57) ABSTRACT

In an aspect of the disclosure, a method, a computer-readable medium, and an apparatus are provided. The method may be performed by a device of a wireless system. In certain configurations, the device instantiates a composition management function (CMF). The device receives, by the CMF from a client node in the wireless system, a client registration request. The device transmits, by the CMF to the client node, a client registration response. The device receives, by the CMF from the client node, a compute resource request. The device transmits, by the CMF to the client node, a compute resource response. In certain configurations, the device instantiates a CMF. The device receives, by the CMF from a compute server function (CSF) of the wireless system, a server registration request. The device transmits, by the CMF to the CSF, a server registration response.

### CROSS-REFERENCE TO RELATED APPLICATION(S)

This application claims the benefits of U.S. Provisional Application Ser. No. 63/506,839, entitled “Compute server registration with a composition management function in a wireless network” and filed on Jun. 8, 2023, and U.S. Provisional Application Ser. No. 63/506,841, entitled “Composition management function for compute offload in a wireless network” and filed on Jun. 8, 2023. The disclosure of each of the above-identified applications is expressly incorporated by reference herein in their entirety.

### TECHNICAL FIELD

The present disclosure relates generally to communication systems, and more particularly, to techniques of methods and apparatuses for a compute server registration with a composition management function for compute offload in a wireless network.

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method may be performed by a device of a wireless system. In certain configurations, the device instantiates a composition management function (CMF). The device receives, by the CMF from a client node in the wireless system, a client registration request. The device transmits, by the CMF to the client node, a client registration response. The device receives, by the CMF from the client node, a compute resource request. The device transmits, by the CMF to the client node, a compute resource response.

In another aspect of the disclosure, a method, a computer-readable medium, and an apparatus are provided. The method may be performed by a device of a wireless system. In certain configurations, the device instantiates a CMF. The device receives, by the CMF from a compute server function (CSF) of the wireless system, a server registration request. The device transmits, by the CMF to the CSF, a server registration response.

In a further aspect of the disclosure, a method, a computer-readable medium, and an apparatus are provided. The method may be performed by a client node of a wireless system. The client node transmits, to a composition management function (CMF) in the wireless system, a client registration request. The client node receives, from the CMF, a client registration response. The client node transmits, to the CMF, a compute resource request. The client node receives, from the CMF, a compute resource response.

The method may be performed by a UE. In certain configurations, the UE initiates a first registration procedure over a first standalone non-public network (SNPN). In response to a first event, the UE performs one or more actions, including: aborting the first registration procedure, resetting a corresponding procedure attempt counter for the first registration procedure, stopping a corresponding timer for the first registration procedure, releasing locally a non-access stratum (NAS) signaling connection if the NAS signaling connection exists, and entering a public land mobile network (PLMN) search state to perform a SNPN selection procedure.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram illustrating an MEC architecture in accordance with a 5G system design.

FIG. 6 is a diagram illustrating an example of compute offloading to diverse locations in a wireless system.

FIG. 7 is a diagram illustrating an exemplary architecture for offloading computing in a manner integrated with communication in a wireless system.

FIG. 8 illustrates an exemplary set of protocols for communication among a client device, a composition management function (CMF), and a compute server function (CSF).

FIG. 9 illustrates an exemplary set of transaction types for a computing control protocol (CCP) between a client device and a CMF.

FIG. 10 illustrates an exemplary set of transaction types for a computing management protocol (CMP) between a CMF and a CSF.

FIG. 11 illustrates an example of a transaction type for a computing offload protocol (COP) between a client device and a CSF.

FIG. 12 illustrates an exemplary architecture for offloading computing in a manner integrated with communication in a wireless system, in which each of a CMF and a CSF is instantiated at a device.

FIG. 13 illustrates an exemplary architecture for offloading computing in a manner integrated with communication in a wireless system, in which a CMF is associated with a distributed unit (DU) of a base station.

FIG. 14 illustrates an exemplary architecture for offloading computing in a manner integrated with communication in a wireless system, in which a CMF is instantiated in the network and a CSF is instantiated at a device.

FIG. 15 illustrates an exemplary set of protocol stacks for transport of CCP over a radio resource control (RRC) protocol.

FIG. 16 illustrates an exemplary set of protocol stacks for transport of CCP over a packet data convergence protocol (PDCP) layer, in which the CMF is associated with a DU of a base station.

FIG. 17 illustrates an exemplary set of protocol stacks for transport of CCP over a PDCP layer, in which the CMF is associated with a CU of a base station.

FIG. 18 illustrates an exemplary set of protocol stacks for transport of CCP between two peer devices, in which one device functions as a client and the other device hosts a CMF.

FIG. 19 illustrates another exemplary set of protocol stacks for transport of CCP between two peer devices, in which one device functions as a client and the other device hosts a CMF.

FIG. 20 illustrates an exemplary set of protocol stacks for transport of COP between a client and a CSF, in which the CSF is associated with a DU of a base station.

FIG. 21 illustrates an exemplary set of protocol stacks for transport of COP between two peer UEs, in which one device functions as a client and the other device hosts a CSF.

FIG. 22 illustrates another exemplary set of protocol stacks for transport of COP between two peer UEs, in which one device functions as a client and the other device hosts a CSF.

FIG. 23 illustrates an exemplary set of protocol stacks for transport of CMP between a CMF and a CSF, in which the CMF is associated with a CU of a base station and the CSF is associated with a DU of a base station.

FIG. 24 illustrates an exemplary set of protocol stacks for transport of CMP between a CMF and a CSF, in which the CMF is associated with one DU of a base station and the CSF is associated with another DU of a base station.

FIG. 25 illustrates an exemplary set of protocol stacks for transport of CMP between a CMF and a CSF, in which the CMF is associated with one CU of a base station and the CSF is associated with another CU of a base station.

FIG. 26 illustrates an exemplary set of protocol stacks for transport of CMP between a CMF and a CSF, in which the CMF is instantiated at a base station and the CSF is hosted at a UE.

FIG. 27 illustrates an exemplary set of protocol stacks for transport of CMP between a CMF and a CSF, in which the CMF is associated with a CU of a base station and the CSF is hosted at a UE.

FIG. 28 illustrates an exemplary set of protocol stacks for transport of CMP between a CMF and a CSF, in which both the CMF and the CSF are hosted at two UEs.

FIG. 29 illustrates an exemplary set of protocol stacks for transport of CMP between a CMF and a CSF, in which the CMF is instantiated at a CN and the CSF is hosted at a UE.

FIG. 30 illustrates an exemplary set of protocol stacks for transport of CMP between a CMF and a CSF, in which the CMF is instantiated at a CN and the CSF is hosted at a UE.

FIG. 31 illustrates an exemplary message flow for a compute session involving a client, a first CSF, a second CSF, and a CMF.

FIG. 32 is a flow chart of a method (process) for wireless communication of a device.

FIG. 33 is a flow chart of a method (process) for wireless communication of a device.

FIG. 34 is a flow chart of a method (process) for wireless communication of a client node.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

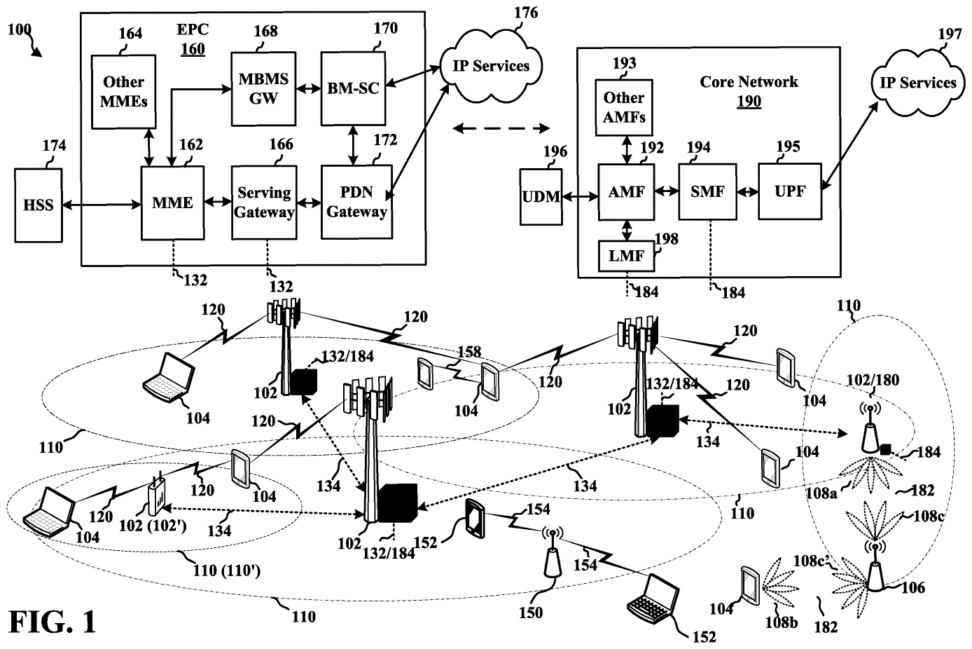

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

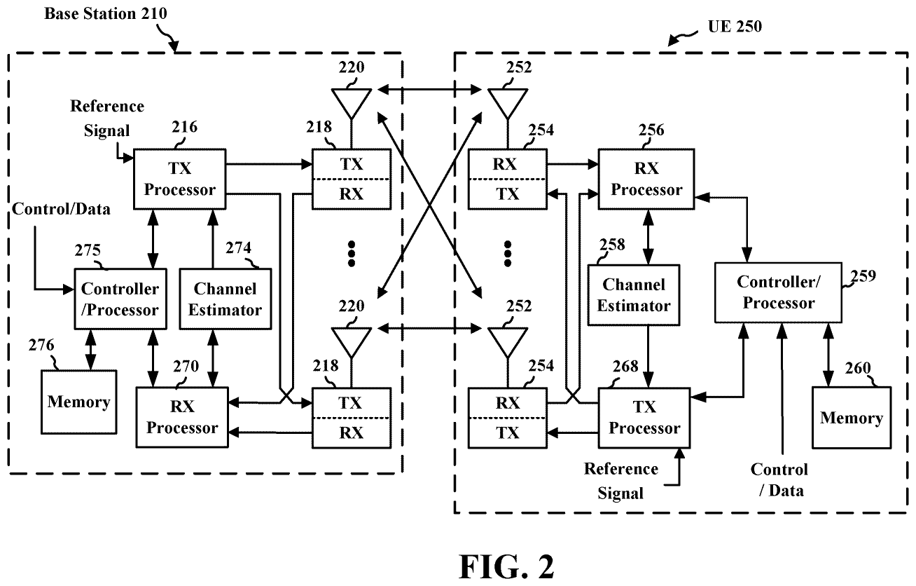

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression / decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

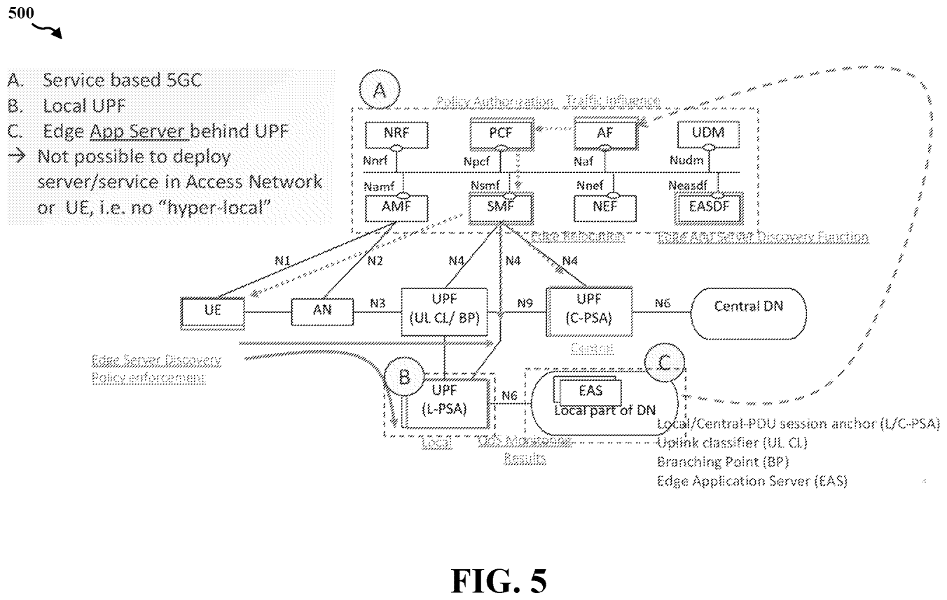

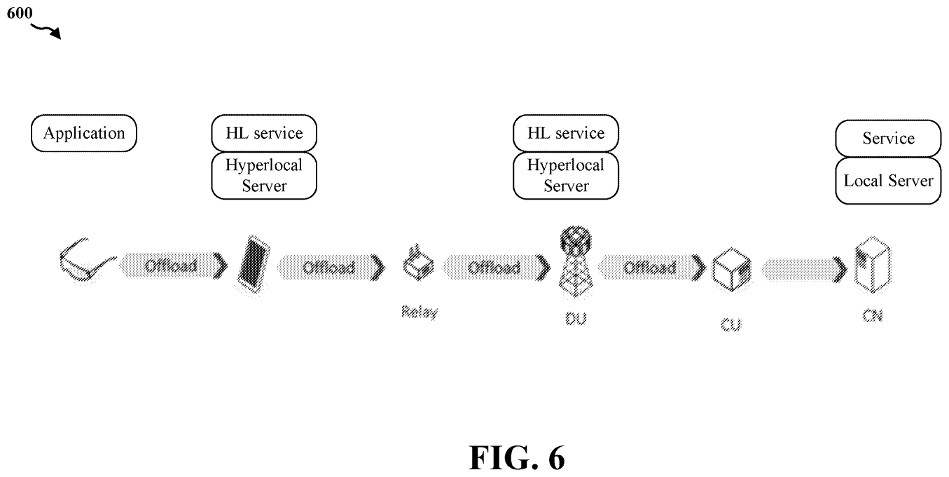

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

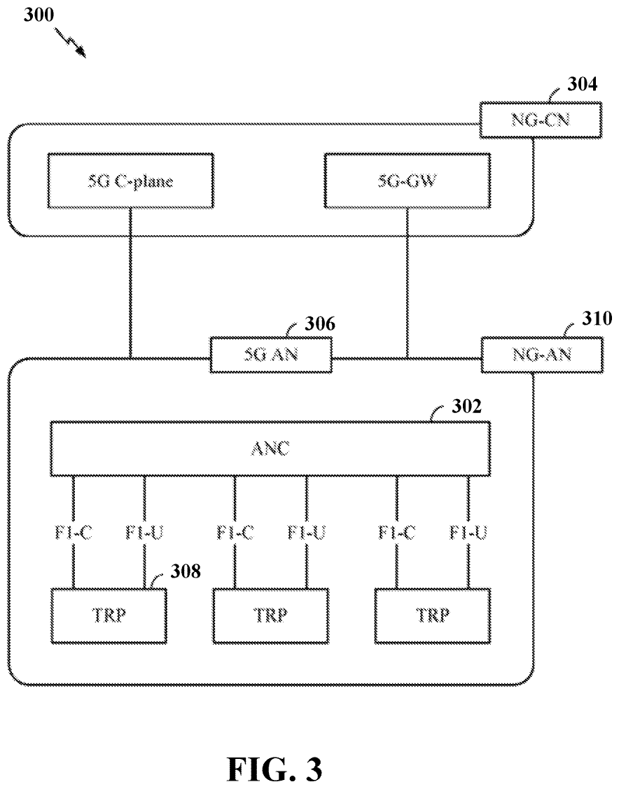

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be present within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

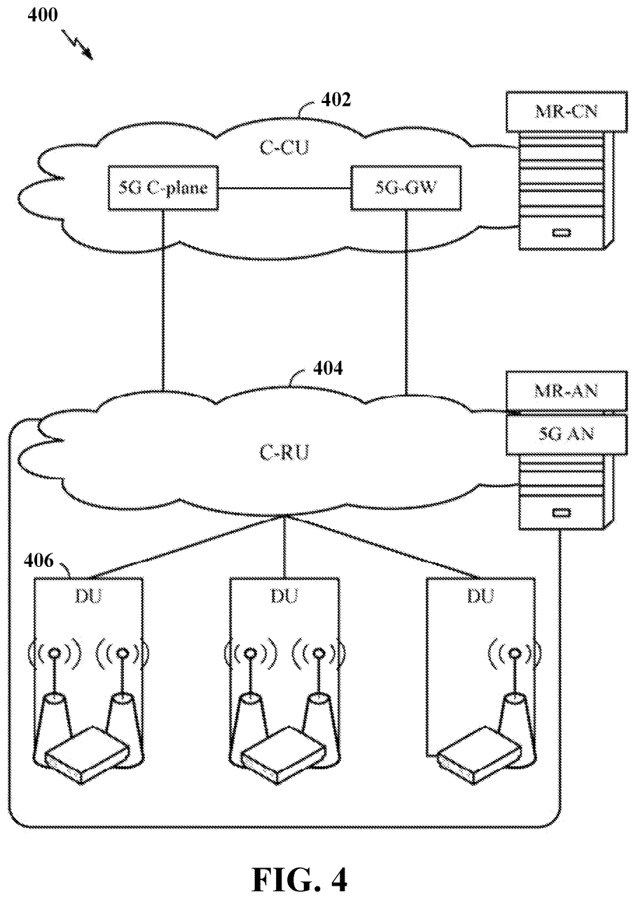

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

In some circumstances, two or more subordinate entities (e.g., UEs) may communicate with each other using sidelink signals. Real-world applications of such sidelink communications may include public safety, proximity services, UE-to-network and/or UE-to-UE relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

In a wireless communication environment, user devices are routinely called upon to execute computational tasks. A typical example occurs in a virtual reality (VR), augmented reality (AR), or mixed reality (MR) application, collectively referred to as XR applications, in which the user device processes a stream of information and renders it to present an environment to the user. However, the computational demands of such an application can be considerable, and a mobile device, which may be battery-limited and/or constrained in processing capability due to its form factor, may have difficulty processing all the data in a timely manner to meet performance requirements of the service. On the other hand, other nodes of the system (e.g. in the vicinity of the less-capable device) may have high processing capabilities; for instance, a network node typically will not need to rely on battery power and can host extensive computing resources. Similarly, a limited-capability device such as a VR headset may be associated with a more capable device such as a smartphone. In such cases, the less-capable device may benefit from offloading some computational tasks to the network node and/or the more-capable device.

Existing systems for compute offload typically operate “over the top” of a communication system. For example, a communication system may provide internet protocol (IP) connectivity between a user device and one or more remote servers that can coordinate and execute computational tasks on behalf of the user device. A widespread example of this mode of operation is Kubernetes, in which a “control plane” orchestrator manages offload of tasks from a client to one or more nodes of a cluster that can execute requested tasks within a container. (It is noted that the Kubernetes usage of the term “control plane” refers to a different concept from the usage in cellular systems.) Such systems have the limitation that they can only operate over a connectivity layer exposed to the client device; that is, they cannot integrate with the underlying communication system to take advantage of low-latency or localized computing capabilities that operate below a user connectivity layer such as a protocol data unit (PDU) layer. There is thus a motivation for a computing model more deeply integrated with the communication system; such an approach is sometimes referred to as integrated communication and computing.

In the Mobile Edge Computing or Multi-access Edge Computing (MEC) architecture defined as part of the 5G system, a user device such as a user equipment (UE) can offload computational tasks to a server in the network associated with a local user plane function (L-UPF). User-plane traffic for the compute server is routed through the local UPF. This architecture allows moderately-low-latency offload to a server at the so-called “edge of the network”, without the latency costs of communication with the operator's core network provided that the L-UPF is deployed as close as possible to the UE; however, the reuse of the legacy user-plane routing mechanism imposes a limit on the latency reduction benefits. As an example, if the base station is disaggregated into a centralized unit (CU) and a distributed unit (DU), the server can only be approximately collocated and deployed up to CU, but not with the DU. There are also further latency impacts associated with traversing the interface to the UPF (in particular in scenarios with more than one UPF in data the path, e.g., a separate “uplink classifier” UPF). Furthermore, given that the L-UPF is deployed within the Core Network (CN), any associated MEC compute server cannot be instantiated at a mobile device, implying that the existing MEC architecture does not enable peer-to-peer offload between mobile devices. A more flexible architecture is sought that addresses these limitations.

Certain aspects of the present disclosure are directed to the operation of a composition management function (CMF), the controlling and/or orchestrating node in a compute offload architecture integrated with the operation of a wireless system.

FIG. 5 is a diagram illustrating an MEC architecture 700 in accordance with a 5G system design. Specifically, FIG. 5 shows a partial representation of the existing 5G MEC architecture. As shown in FIG. 5a, the 5G core network (5GC), with nodes interconnected via service-based interfaces (SBIs), is shown in block A of the figure and comprises the following nodes: a network repository function (NRF), which acts as a manager for registration and services offered by other network functions; an access and mobility management function (AMF), which coordinates operations of a UE in the access network (AN); a policy control function (PCF), which controls allocation of user data traffic to bearers in accordance with system policies; a session management function (SMF), which handles sessions of user services; an application function (AF), which controls the application and supports the determination of traffic policies; a network exposure function (NEF), which manages exposure of services to third party AFs over APIs within the system; a Unified Data Management (UDM), which acts as a repository for subscription data; and an edge application server discovery function (EASDF), which is responsible for discovery of servers operating applications that can operate with computing at the edge of the network. (Additional nodes, not shown in the figure, may also be included in the 5GC.) The nodes shown as being outside the 5GC include a UE; an AN, which provides radio access for the UE; a first UPF operating as an uplink classifier (UL CL) and branch point (BP); a second UPF operating as a central protocol data unit (PDU) session anchor (C-PSA); a third UPF, marked as block B in the figure, operating as a local PDU session anchor (L-PSA); and a data network (DN), which is external to the operator's system and is shown in the figure as decomposed into a central part and a local part, with the local part marked as block C in the figure and containing an edge application server (EAS). The EAS hosts the computational activity that takes place at the edge of the network, in cooperation with the AF, based on traffic steered from the UE to the L-PSA UPF. It is noted that the UPFs may be considered as nodes of the 5GC, but because of their unique role in distributing traffic in the MEC architecture, as well as to emphasise the local nature of the termination point, they are shown outside block A in the figure.

FIG. 6 is a diagram illustrating an example of compute offloading to diverse locations in a wireless system. As shown in FIG. 6, the exemplary wireless system 600 may, for example, be considered as representative of a 6G system. An application runs on an XR device (the headset at the left of the figure), connected by a short-range link to a smartphone that receives service from the wireless system. The smartphone is connected through a relay node to a base station, which is disaggregated into at least one DU (one shown in the figure) and a CU, and the base station is connected to a CN. The application running on the headset may offload computational work to various nodes located throughout the system. For example, the figure shows a first hyperlocal server hosted at the smartphone, a second hyperlocal server hosted at (or near) the DU, a local server (which may, for example, be a local MEC server) closely collocated with the CU, and additional computational capacity hosted in the CN (not shown as a participant in compute offload activity in the figure). It is noted that the local server may be deployed in association with a local UPF, i.e., closely associated with the CU, but in terms of modelling the roles of nodes in the system, it is still located at a CN node. Each server (local or hyperlocal) may offer a computational service, and the application may take advantage of these services to offload some of its computational work. For example, latency-sensitive tasks may be offloaded to the smartphone or the hyperlocal service in the DU, while demanding but less latency-sensitive tasks may be offloaded to the local server.

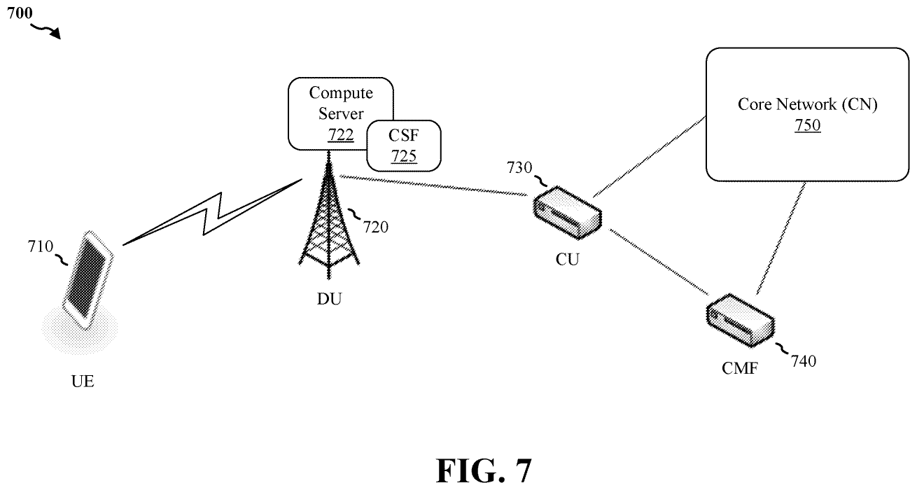

FIG. 7 is a diagram illustrating an exemplary architecture for offloading computing in a manner integrated with communication in a wireless system. As shown in FIG. 7, in the exemplary wireless system 700, a UE 710 is connected to the system through an air interface with a DU 720. The DU 720 is closely collocated with a compute server which can accept offloading of compute work, and the DU 720 hosts a compute server function (CSF) 725 that acts as a standardized proxy for the compute server 722 towards the other nodes in the wireless system. The DU 720 is connected by an interface to a CU 730; the DU 720 and CU 730 (potentially along with other DUs, not shown in the figure) constitute a base station. The CU 730 is connected to a CN 750, which provides connectivity to a data network (not shown). The arrangement of the elements including the UE 710, the DU 720, the CU 730, and the CN 740 may be in accordance with the existing 5G system. Along with the CSF 725 already mentioned, the figure adds a composition management function (CMF) 740, which is a node of the network that is connected to the CU 730 (in this example) and to the CN 750. The CMF 740 may be viewed as a controller and/or orchestrator node for compute offload in the wireless system, responsible for the coordination and allocation of servers to offer compute resources for offload of computational tasks from a client. In some embodiments, the CMF 740 may be considered as a node of the AN. In other embodiments, the CMF 740 may be considered as a node of the CN. In some embodiments, the client may be in a device such as a UE 710. In other embodiments, the client may be in a fixed node such as a network node.

In certain embodiments, other connectivity topologies can be conceived for an environment like that shown in FIG. 7. For example, the CMF 740 may obtain connectivity to the CN 750 through the CU 730. Alternatively, the CMF 740 may have a direct link to the DU 720, and so on. In this context, the UE 710 may communicate with the CMF 740 using a protocol that traverses the DU 720 and the CU 730. The CMF 740 may communicate with the CSF 725 (as a proxy for the compute server 722) using a protocol that traverses the CU 730 and DU 720. The UE 710 may communicate with the CSF 725 (as a proxy for the compute server 722) using a protocol that traverses the DU 720. The protocol stacks for carrying these control protocols may vary according to additional aspects of the architecture, but they are assumed to provide the necessary connectivity between endpoints: between the UE 710 and the CMF 740 for a first protocol, hereinafter referred to as a computing control protocol (CCP); between the CMF 740 and (one or more instances of) the CSF 725 for a second protocol, hereinafter referred to as a computing management protocol (CMP); and between the UE 710 and (one or more instances of) the CSF 725 for a third protocol, hereinafter referred to as a computing offload protocol (COP). In some embodiments, COP may be realized by user-plane (UP) transport of compute data or by communications of a new “compute plane” rather than by a control-plane protocol. In some aspects of the following discussion, the distinction between the CSF 725 and the compute server 722 may be elided. From the functional point of view, it is convenient to consider the UE 710 and the CMF 740 as being in correspondence with the compute server, without explicit consideration of the CSF 725, which may act only as a network proxy to expose the functions of the compute server 722 to the standardized nodes of the wireless system 700.

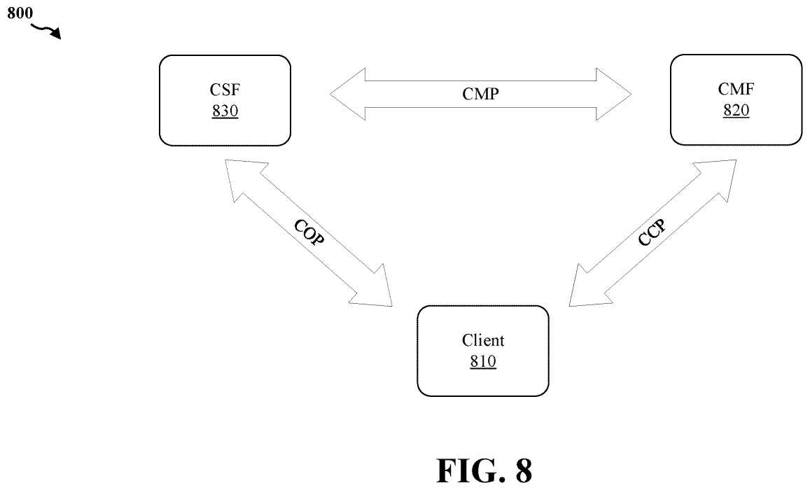

FIG. 8 illustrates an exemplary set of protocols for communication among a client device, a CMF, and a CSF. As shown in FIG. 8, the client device 810 (e.g., UE 710) communicates with the CMF 820 (e.g., CMF 740) via CCP and with the CSF 830 (e.g., CSF 725) via COP. The CMF 820 communicates with the CSF 830 via CMP and with the client device 810 via CCP. The CSF 830 communicates with the client device 810 via COP and with the CMF 820 via CMP. Any or all of the protocols CCP, CMP, and COP may be realized as a protocol defined on a communication (point-to-point) reference point and/or as an application programming interface (API) defined on an SBI. In case one of the protocols is defined as a protocol on a reference point, the operations of the protocol may be understood as messages with specific purposes that trigger standardized and/or implementation-dependent behavior in the nodes that receive them. In case one of the protocols is defined as an API on an SBI, the operations of the protocol may be understood as invocations of services via the API that trigger standardized and/or implementation-dependent handling as the node that receives a service invocation, executes a related functional behavior, and optionally responds with a service invocation. In the present disclosure document, these operations are referred to as transactions of a protocol, but it should be understood throughout that substantially the same functional behavior can be realized while modelling the operations as invocations of an API.

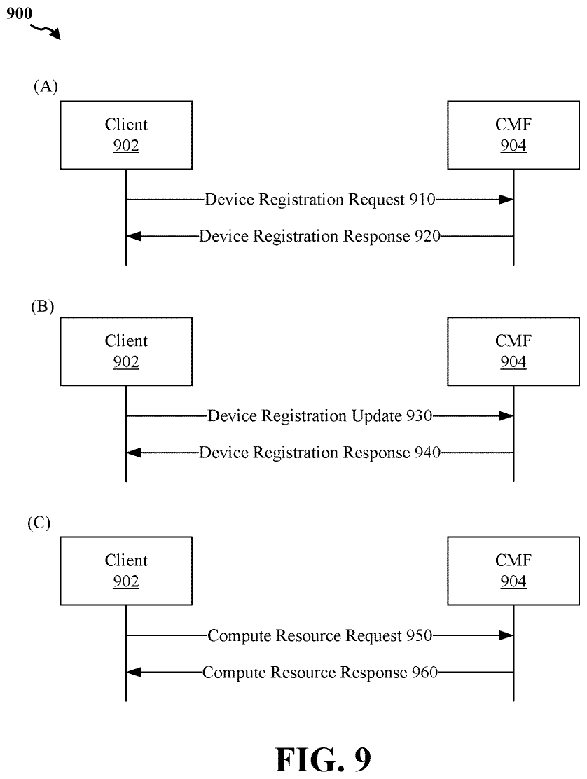

FIG. 9 illustrates an exemplary set of transaction types for a CCP between a client device and a CMF. As shown in FIG. 9, the first flow (A) shows a transaction for a registration of the client device 902 with the CMF 904, in which the client 902 sends a first message to request registration (labelled as a Device Registration Request message 910) and the CMF 904 responds with a second message to confirm or deny the registration (labelled as a Device Registration Response message 920). The Device Registration Request message 910 may comprise a variety of information about the client device 902, such as capability information, a profile of supported applications and/or compute profiles on the client, radio information, and so on. The Device Registration Response 920 may contain a field such as a flag indicating whether the registration is accepted, information about one or more available compute servers, and so on. The second flow (B) shows a transaction for a registration update of the client device 902 registration with the CMF 904, in which the client 902 sends a third message to request an update of its registration information (labelled as a Device Registration Update message 930) and the CMF 904 responds with a fourth message to confirm or deny the update (labelled as a Device Registration Response message 940). The Device Registration Update message 930 may contain similar information to that described above in the first message 910. The Device Registration Update message 930 may be sent due to a change of conditions at the client device 902, such as a change in its capabilities, a change in its supported applications and/or compute profiles, a change in its radio conditions, and so on. The Device Registration Response message 940 may contain a field such as a flag indicating whether the registration update is accepted, information about one or more available compute servers, and so on. The third flow (C) shows a transaction for a request from the client 902 for compute resources for one or more computational tasks, in which the client 902 sends a fifth message to request information on one or more computing resources (labelled as a Compute Resource Request message 950) and the CMF 904 responds with a sixth message providing or denying the requested information (labelled as a Compute Resource Response message 960). The Compute Resource Request message 950 may contain a description of the requested compute resources, such as a profile of an expected compute load from the one or more requested tasks, a quantified level of requested computational support (e.g., a metric for anticipated compute cycles required by the one or more requested tasks over time), a latency requirement, an identifier of a requested CSF (or server associated with the CSF), an identifier of a requested task, and so on. The Compute Resource Response message 960 may contain a field such as a flag indicating whether the compute resource request is accepted, one or more identifiers of one or more assigned CSFs (or servers associated with the CSFs), an image of a requested task, and so on.

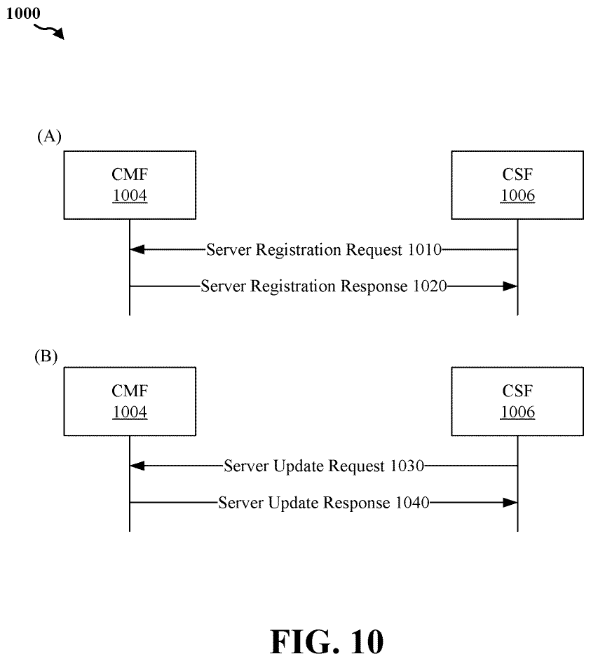

FIG. 10 illustrates an exemplary set of transaction types for a CMP between a CMF and a CSF. As shown in FIG. 10, the first flow (A) shows a request from a CSF 1006 to a CMF 1004 to register a compute server associated with the CSF 1006. The CSF 1006 sends a first message requesting registration of the server (labelled as a Server Registration Request message 1010). The Server Registration Request message 1010 may contain information about the compute capabilities of the server (such as a maximum value for a load metric, an achievable latency for a task with specified compute demand assumptions, and so on), an indication that the server will accept one or more defined tasks (such as a list of admissible task identifiers referencing a repository of task images), and so on. The CMF 1004 sends a second message confirming or denying registration of the server (labelled as a Server Registration Response message 1020). The Server Registration Response message 1020 may contain a field such as a flag indicating whether the server registration is accepted, one or more runtime images of tasks that the server may be expected to execute, and so on. The second flow (B) illustrates a request from a CSF 1006 to a CMF 1004 to update a registration of a compute server associated with the CSF 1006 (which may be necessary, for example, if the capabilities and/or current demand on the server change). The CSF 1006 sends a third message requesting an update of the registration information of the server (labelled as a Server Update Request message 1030). The Server Update Request message 1030 may contain similar information to the first message, such as information about the compute capabilities of the server, an indication that the server will accept one or more defined tasks, and so on. The CMF 1004 sends a fourth message confirming or denying the update of the server (labelled as a Server Update Response message 1040). The Server Update Response message 1040 may contain a field such as a flag indicating whether the server update is accepted, one or more runtime images of tasks that the server may be expected to execute, and so on.

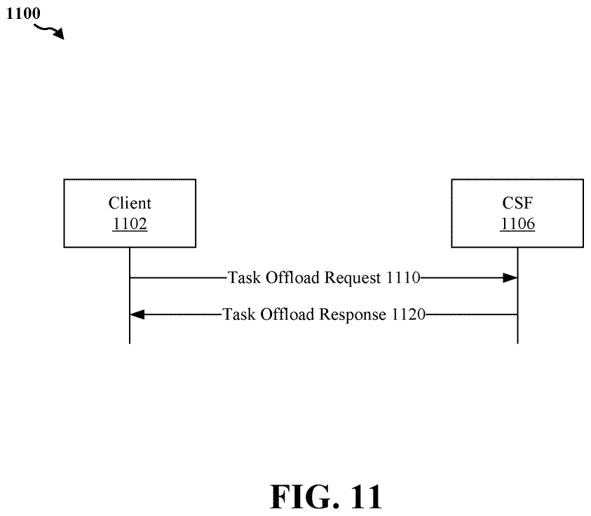

FIG. 11 illustrates an example of a transaction type for a COP between a client device and a CSF. As shown in FIG. 11, the flow illustrates a request for compute offload of one or more tasks from a client device 1102 to a compute server represented by a CSF 1106. The client 1102 sends a first message requesting offload of the one or more tasks to the server (labelled as a Task Offload Request message 1110). The Task Offload Request message 1110 may contain one or more performance requirements (for instance, a compute profile, a requested level of computational support, a latency requirement, and so on), one or more identifiers of the requested one or more tasks and/or one or more runtime images of the requested one or more tasks, and so on. The CSF 1106 sends a second message (labelled as a Task Offload Response message 1120), which may indicate whether the CSF 1106 accepts the task. In some embodiments, the Task Offload Response message 1120 may be sent after the task has been executed at the compute server associated with the CSF 1106, and in this case the Task Offload Response message 1120 may include a result of executing the task. In other embodiments, the Task Offload Response message 1120 may be sent upon the CSF 1106 determining whether to accept the task, and it may be followed by a third message (for example, a Task Offload Result message, which is not shown in FIG. 11) comprising a result of executing the task.

In the exemplary wireless system 700 as shown in FIG. 7, the CMF 740 and the CSF 725 are embodied in nodes of the network. However, it is possible that the wireless system may have an alternative architecture from the exemplary wireless system 700.

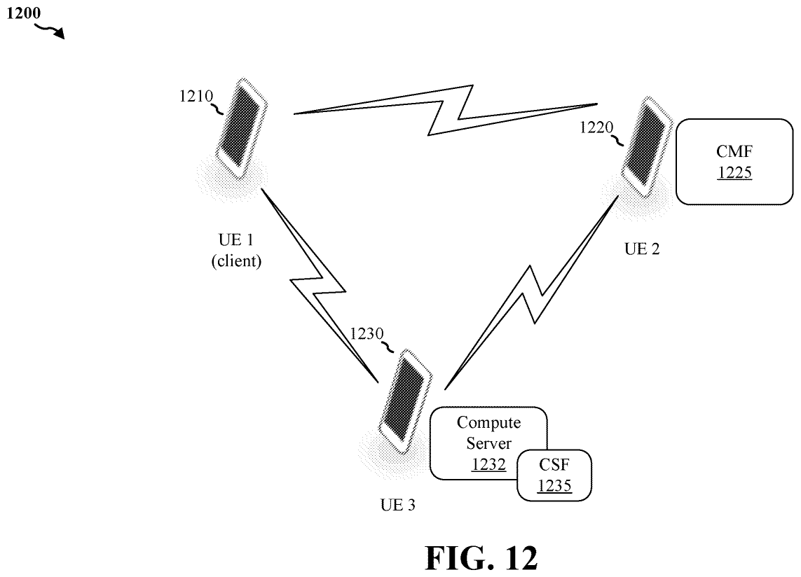

FIG. 12 illustrates an exemplary architecture for offloading computing in a manner integrated with communication in a wireless system, in which each of a CMF and a CSF is instantiated at a device (e.g., UE). As shown in FIG. 12, the wireless system 1200 includes three UEs 1210, 1220 and 1230 (respectively referred to as the UE 1, UE 2 and UE 3), and there is no network node shown in the figure. The three UEs 1210, 1220 and 1230 may be out of cellular network coverage and communicating in a peer-to-peer, mesh, or ad-hoc network, or one or more of them may be in coverage and in communication with a network, but interacting with a compute architecture embodied at the other UEs. In FIG. 12, the UE 1210 (i.e., UE 1) is a client device, the CMF 1225 is instantiated at the UE 1220 (i.e., UE 2), and the CSF 1235 and compute server 1232 are embodied at the UE 1230 (i.e., UE 3), but it should be appreciated that these roles may be combined. For instance, in some embodiments, the CMF and client may be collocated in a single device, meaning that the client device has the responsibility of coordinating compute resources at other UEs. In some embodiments, the CMF and the compute server/CSF may be collocated in a single device, meaning that the CMF coordinates compute resources from one or more devices including itself. In principle, the client and the compute server/CSF could be considered as collocated at a single device in some embodiments, but the client device would not normally depend on an external CMF to control its own compute resources. This situation may instead be modelled as the client device taking autonomous decisions about its own computation, but there is no fundamental violation of principle in collocating the client and CSF/server. The air interfaces between the devices may be short-range radio interfaces using one or a combination of radio technologies, such as a sidelink technology, WiFi, Bluetooth, and so on. In some embodiments, one or more of the air interfaces in the figure may be replaced by wired connections.

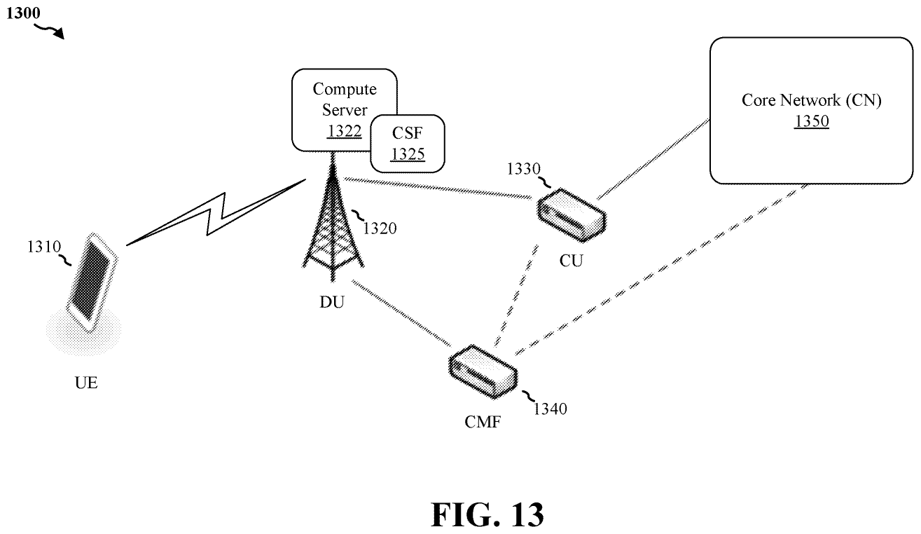

FIG. 13 illustrates an exemplary architecture for offloading computing in a manner integrated with communication in a wireless system, in which a CMF is associated with a DU of a base station. In the exemplary wireless system 1300 as shown in FIG. 13, the architecture of the UE 1310, the DU 1320, the compute server 1322, the CSF 1325, the CU 1330 and the CN 1350 are similar to the UE 710, the DU 720, the compute server 722, the CSF 725, the CU 730 and the CN 750 in the wireless system 700, and the only difference exists in that the CMF 1340 is associated with (e.g., closely collocated with) the DU 1320, rather than the CU 1330. This alternative may allow low-latency communication between the client device and the CMF 1340, which may be desirable if the CMF 1340 is on the critical path for offloading a task. As one example, if the client device (i.e., UE 1310) encounters a task that it has not previously authorized with the CMF 1340 (and for which it may need to retrieve a runtime image, for example), any delay in the device's communication with the CMF 1340 may be reflected in a corresponding delay in the execution of the task. FIG. 13 shows the CMF 1340 with alternative or complementary interfaces (represented by dashed lines) connecting it to the CU 1330 and the CN 1350, and depending on the network architecture as a whole, either or both of these interfaces may be used. For example, if the CMF 1340 is responsible for orchestrating compute resources at the CU 1330 as well as at one or more DUs 1320 and/or one or more devices 1310, a direct connection between the CMF 1340 and the CU 1330 facilitates such operation. As another example, if the CMF 1340 is required to interact with nodes in the CN 1350, a direct connection between the CMF 1340 and the CN 1350 may be useful. In some environments, such as a setting in which all the interfaces in the network are SBIs, the direct connections shown in the figure may be replaced by a “service bus” concept that allows any node to communicate with any other node, according to the requirements of the exposed services.

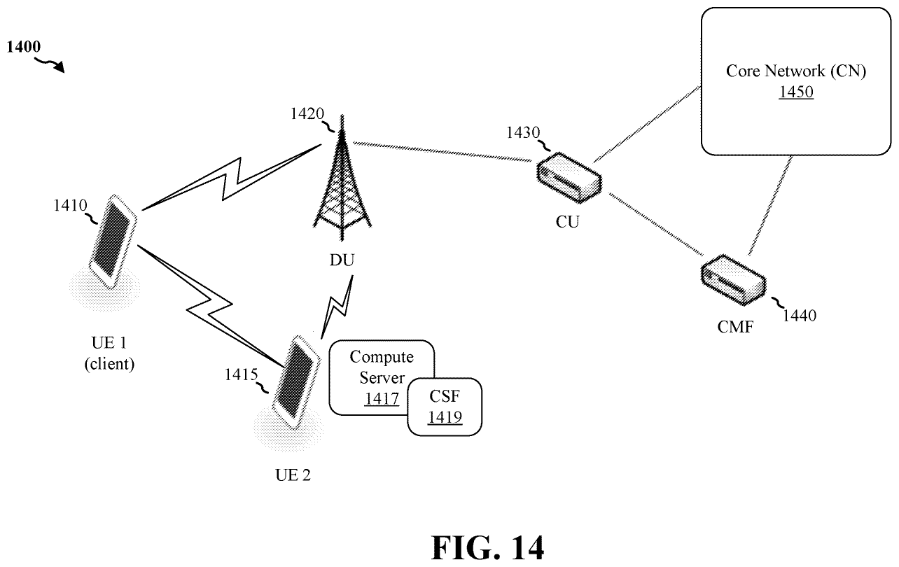

FIG. 14 illustrates an exemplary architecture for offloading computing in a manner integrated with communication in a wireless system, in which a CMF is instantiated in the network and a CSF (along with its corresponding compute server) is instantiated at a device. As described earlier, it may also be desirable to perform task offload from a first device (for example, a first UE) to a second device (for example, a second UE). Accordingly, it is desirable to instantiate a CSF at a device instead of a network node. In the exemplary wireless system 1400 as shown in FIG. 14, the architecture of the UE 1410, the DU 1420, the CU 1430, the CMF 1440 and the CN 1450 are similar to the UE 710, the DU 720, the CU 730, the CMF 740 and the CN 750 in the wireless system 700, and the only difference exists in that a second UE 1415 (labelled as UE 2) is provided, and the compute server 1417 and the CSF 1419 are instantiated at the UE 1415. The roles of the client device (i.e., UE 1410, labelled as UE 1), the CMF 1440, and the CSF 1419 are similar to those described above, but the routing of the protocols differs. Specifically, the CMF 1440 is instantiated in the network, associated with a CU 1430 of a base station, and the client device (i.e., the UE 1410) is in communication with the network via an air interface to a DU 1420 of the base station. Further, a second UE 1415 (labelled as UE 2) is also in communication with the DU 1420 of the base station via a first air interface, and with the client device (i.e., the UE 1410) via a second air interface. For example, the first air interface may be a Uu interface linking UEs to a cellular network, and the second air interface may be a short-range interface linking peer devices to one another, such as a sidelink or PC5 interface, or another radio technology such as Bluetooth or WiFi. In some embodiments, the UE 1 and UE 2 may be connected by a wired rather than a wireless interface. In some embodiments, UE 1 and UE 2 may be connected by an ideal interface. The CMF 1440 may communicate via CMP (or a similar compute management protocol) with the CSF 1419 located at UE 2, and the client device (i.e., UE 1) may communicate via COP (or a similar computing offload protocol) with the CSF 1419 located at UE 2. In some embodiments, the UE 1 and/or UE 2 may be connected indirectly to the network using a relaying or mesh architecture, in which their communication link with the network is factored through one or more intermediate nodes, rather than connected directly to the network as shown in the figure. In certain embodiments, it should be appreciated that an architecture with a first compute server (e.g., compute server 1417) and a first CSF (e.g., CSF 1419) located at a device such as the UE 1415 (i.e., UE 2) may coexist with an architecture with a second compute server (e.g., computer server 722) and a second CSF (e.g., CSF 725) located at a network node such as the DU 720 as shown in FIG. 7. That is, the client device (i.e., UE 1) may be able to offload one or more tasks to the first compute server and the second compute server, under the management of the CMF 1440.

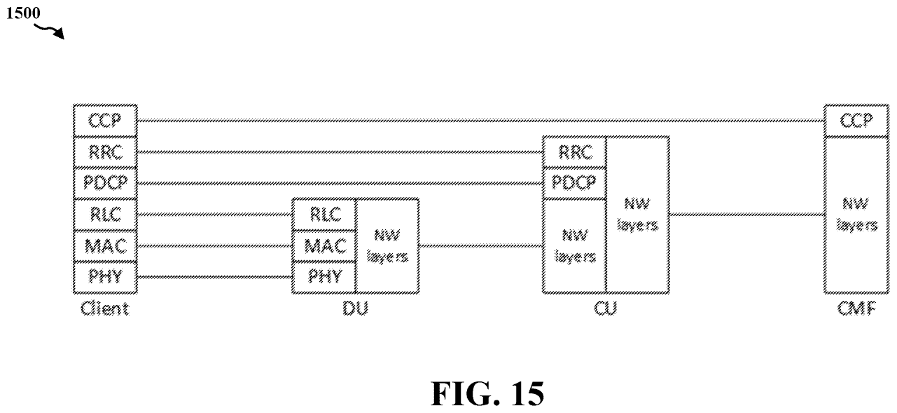

FIG. 15 illustrates an exemplary set of protocol stacks for transport of CCP over a RRC protocol, for a case where the CMF is associated with (e.g., closely collocated with) the CU. In the exemplary set 1500 of protocol stacks, the client device instantiates a physical (PHY) layer, a medium access control (MAC) layer, a radio link control (RLC) layer, a packet data convergence protocol (PDCP) layer, an RRC layer, and a CCP layer. The PHY, MAC, and RLC layers may terminate at the DU. The DU and the CU are connected by network interfaces and protocols which are out of the scope of this discussion, represented in the figure as “NW layers”. The client's PDCP and RRC layers may terminate at the CU. The CU and the CMF are connected in a manner that may be proprietary or specified, relying on network interfaces outside the scope of this discussion, again represented in the figure as “NW layers”. The client's CCP layer may terminate at the CMF. This layering may be achieved, for instance, by encapsulating one or more CCP messages as PDUs in an RRC message, so that when the CU interprets the RRC message, it forwards the CCP PDU to the CMF for processing. It should be appreciated that the layers in the figure are exemplary, and particular protocol layers may be modified, reordered, eliminated, combined, and/or replaced by other layers with similar or different functions. As one example, the so-called layer 2 sublayers, comprising MAC, RLC, and PDCP, may be replaced by any combination of sublayers that can deliver an RRC PDU between the client and the CU. In certain embodiments, the exemplary set 1500 of protocol stacks may be implemented in the exemplary wireless system 1200 as shown in FIG. 12.

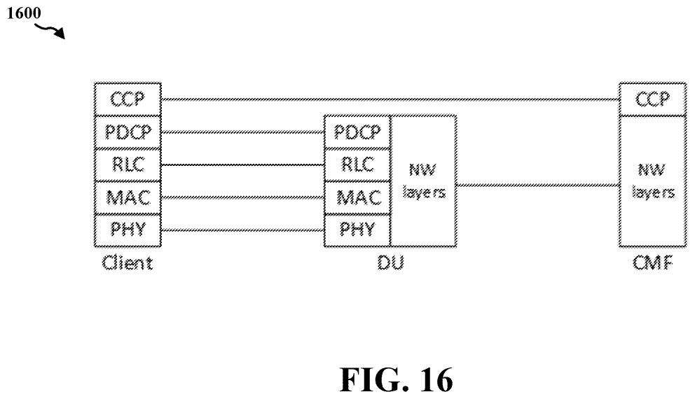

FIG. 16 illustrates an exemplary set of protocol stacks for transport of CCP over a PDCP layer, for a case where the CMF is associated with (e.g., closely collocated with) the DU. In the exemplary set 1600 of protocol stacks, the client device instantiates a PHY layer, a MAC layer, an RLC layer, a PDCP layer, and a CCP layer. The PHY, MAC, RLC, and PDCP layers may terminate at the DU. The DU and the CMF are connected in a matter that may be proprietary or specified, relying on network interfaces outside the scope of this discussion, represented in the figure as “NW layers”. The client's CCP layer may terminate in the CMF. This layering may be achieved, for instance, by encapsulating one or more CCP messages as PDUs communicated over the PDCP layer. It should be noted that the protocol stacks of FIG. 16 include termination of PDCP at the DU, which is a divergence from current practice in 5G systems; this is because it is necessary to have security (which is a PDCP function in 5G) terminated at the node where the CMF resides. Accordingly, compared to 5G norms, one or more protocol layer termination points may be relocated from the CU to the DU. In some embodiments, protocol layers may terminate at different locations for different bearers or services; for example, PDCP might be terminated at the DU for a radio bearer carrying CCP signaling, but at the CU for other radio bearers. In certain embodiments, the exemplary set 1600 of protocol stacks may be implemented in the exemplary wireless system 1300 as shown in FIG. 13.

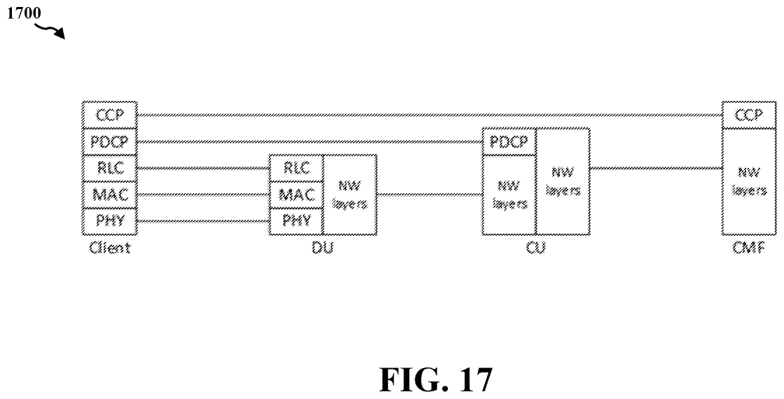

FIG. 17 illustrates an exemplary set of protocol stacks for transport of CCP over a PDCP layer, for a case where the CMF is associated with a CU of a base station. In the exemplary set 1700 of protocol stacks, the CMF is associated with (e.g., closely collocated with) the CU, but instead of being transported as a PDU encapsulated inside an RRC message, a CCP PDU is carried directly over the PDCP protocol, i.e., a PDCP service data unit (SDU) may comprise a CCP PDU. The termination points of all the included protocols are the same as in FIG. 8 (the RRC layer is not shown since it has no role in CCP processing in this model). The PDCP layer at the CU may differentiate between RRC PDUs, which need to be delivered to an RRC layer and processed at the CU, and CCP PDUs, which need to be forwarded to the CMF and processed there. This differentiation may depend on a radio bearer identity or on a protocol discriminator in a PDCP PDU, for example. The PDCP layer at the client may also differentiate between RRC PDUs and CCP PDUs, each of which needs to be delivered to its respective protocol layer for processing. This differentiation may depend on a radio bearer identity or on a protocol discriminator in a PDCP PDU, for instance. In some embodiments, one or more radio bearers may be reserved for carrying CCP between the client device and the CMF; these radio bearers may be considered as data radio bearers of a user plane of the wireless system, signaling radio bearers of a control plane of the wireless system, or compute radio bearers of a compute plane of the wireless system. In certain embodiments, the exemplary set 1700 of protocol stacks may be implemented in the exemplary wireless system 700 as shown in FIG. 7 or the exemplary wireless system 1400 as shown in FIG. 14.

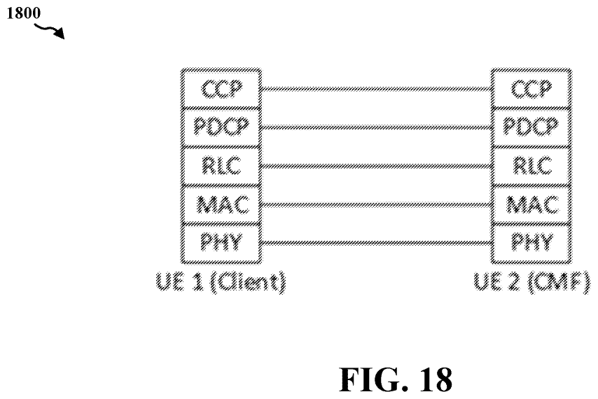

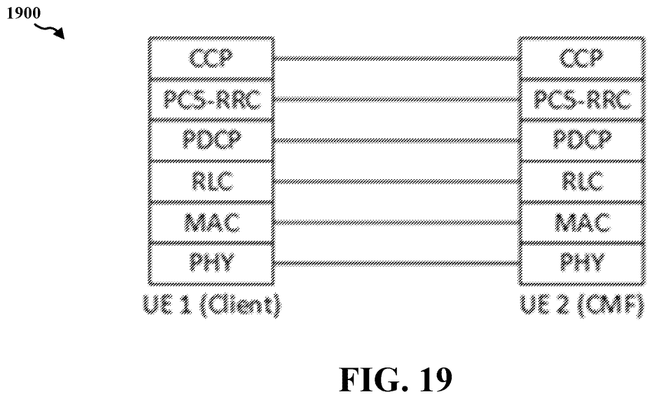

FIG. 18 and FIG. 19 illustrate two exemplary sets of protocol stacks for transport of CCP between two peer devices, wherein one device functions as a client and the other device hosts a CMF. In the exemplary sets 1800 and 1900 of protocol stacks, the UE 1 functions as a client (e.g., by hosting a client application) and the UE 2 hosts a CMF. In the exemplary set 2000 of protocol stacks, CCP is carried directly over PDCP, and in the exemplary set 2100 of protocol stacks, CCP is encapsulated in a PC5 radio resource control (PC5-RRC) protocol. The encapsulation of CCP in PC5-RRC messages is similar to the encapsulation of CCP in RRC messages as previously described. In certain embodiments, the exemplary sets 1800 and 1900 of protocol stacks may be implemented in the exemplary wireless system 1200 as shown in FIG. 12.

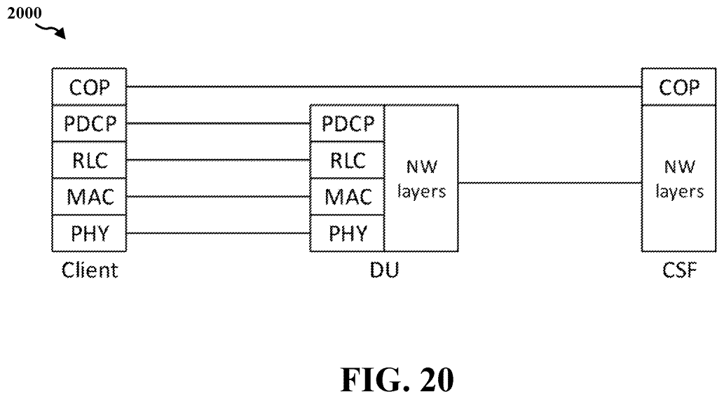

FIG. 20 illustrates an exemplary set of protocol stacks for transport of COP between a client (located, for instance, in a UE) and a CSF, in which the CSF is associated with a DU of a base station. In the exemplary set 2000 of protocol stacks, COP is carried directly over a PDCP layer terminated between the client and the DU. The interface between the DU and the CSF may be proprietary or specified; it may be considered as an internal interface of the DU. In some embodiments, one or more radio bearers may be reserved for carrying COP between the client device and the CSF; these radio bearers may be considered as data radio bearers of a user plane of the wireless system, signaling radio bearers of a control plane of the wireless system, or compute radio bearers of a compute plane of the wireless system. In certain embodiments, the exemplary set 2000 of protocol stacks may be implemented in the exemplary wireless system 700 as shown in FIG. 7, the exemplary wireless system 1300 as shown in FIG. 13, or the exemplary wireless system 1400 as shown in FIG. 14.

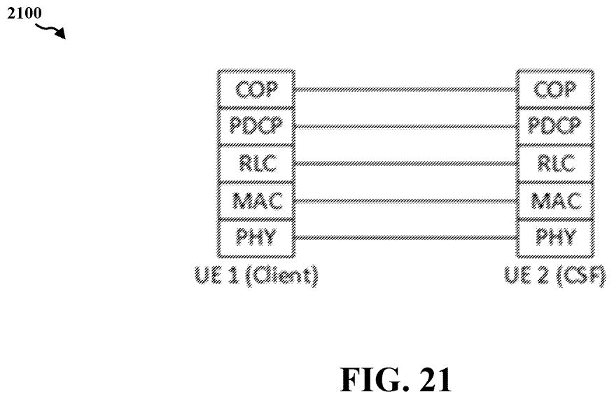

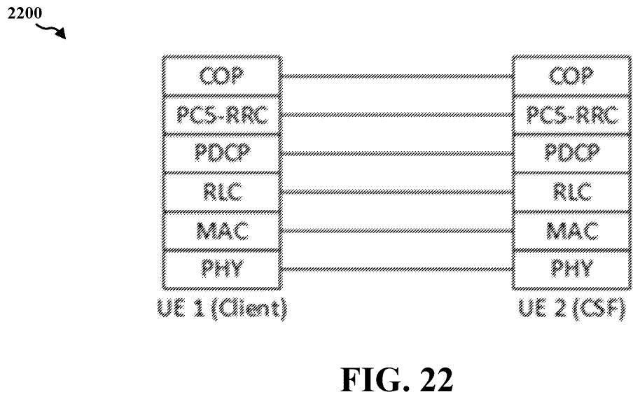

FIG. 21 and FIG. 22 illustrate two exemplary sets of protocol stacks for transport of COP between two peer UEs, in which one device functions as a client and the other device hosts a CSF. In the exemplary sets 2100 and 2200 of protocol stacks, the UE 1 functions as a client (e.g., hosting a client application), and the UE 2 hosts a CSF. In the exemplary set 2100 of protocol stacks, COP is carried directly over PDCP, i.e., a PDCP SDU may comprise a COP PDU. In the exemplary set 2200 of protocol stacks, COP is carried over a PC5-RRC protocol, for instance, by being encapsulated in one or more PC5-RRC messages. In certain embodiments, the exemplary sets 2100 and 2200 of protocol stacks may be implemented in the exemplary wireless system 1200 as shown in FIG. 12.

There are various protocol stack options for the transport of CMP between a CMF and a CSF, because the transport depends on the network implementation and configuration. If the CMF is located at a CU and the CSF at a DU, the CMP protocol may be carried over a network protocol such as an F1 application protocol (F1AP). If the CMF is located at a DU and the CSF at the same DU, the interface carrying CMP between them may be proprietary or specified, and it may be considered as an internal interface between functions of the DU. If the CMF is located at a DU and the CSF at a different DU, CMP may be carried over a DU-DU interface, using, for instance, an application protocol or API applicable to that interface. If the CMF is in the network and the CSF is at a UE, CMP may be carried over an air interface, with various protocol options similar to FIGS. 8, 9, and 10; that is, CMP may be carried over RRC or over PDCP, between the UE and a DU or between the UE and a CU. If the CMF and CSF are both located at UEs, CMP may be carried over a short-range interface between the two UEs, with options similar to FIG. 14 allowing CMP to be carried over PDCP or over PC5-RRC. In the latter cases where CMP is carried over an air interface, it may be associated with specific radio bearers, which may be modelled as data radio bearers of a user plane of the wireless system, signaling radio bearers of a control plane of the wireless system, or compute radio bearers of a compute plane of the wireless system.

In some embodiments (not illustrated), a CSF may be instantiated at a CU of a base station, and COP may be terminated between a client device and a CSF at a CU. In such a case, COP may be carried over an RRC protocol (e.g., by encapsulation of a COP PDU in an RRC message) and/or over a PDCP layer. In case COP is carried over PDCP, COP PDUs may be distinguished from other upper-layer PDUs by a bearer identity, a protocol discriminator, and so on. In some embodiments, one or more radio bearers may be reserved for carrying COP between the client device and the CSF; these radio bearers may be considered as data radio bearers of a user plane of the wireless system, signalling radio bearers of a control plane of the wireless system, or compute radio bearers of a compute plane of the wireless system.

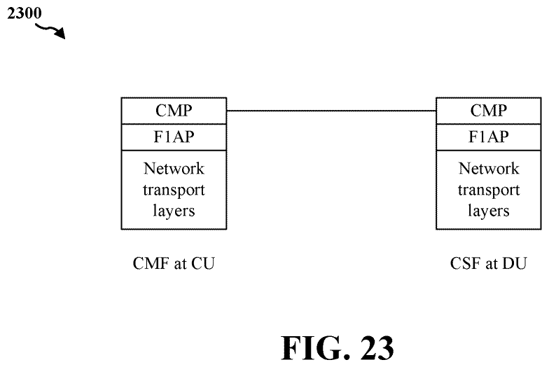

FIG. 23 illustrates an exemplary set of protocol stacks for transport of CMP between a CMF and a CSF, in which the CMF is associated with a CU of a base station and the CSF is associated with a DU of a base station. In the exemplary set 2300 of protocol stacks, the CMP protocol may be carried over the F1AP. It should be noted that the roles of the nodes may be switched, which applies to the case of a CMF at the DU and a CSF at the CU. Further, future specification may include a different protocol from the F1AP on the F1 interface between a CU and a DU, and CMP may be carried over this protocol in a CU-DU interface.

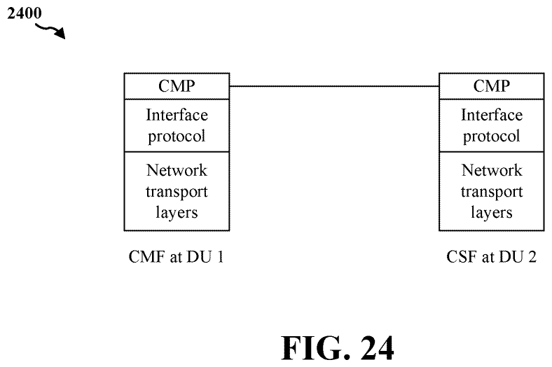

FIG. 24 illustrates an exemplary set of protocol stacks for transport of CMP between a CMF and a CSF, in which the CMF is associated with one DU of a base station and the CSF is associated with another DU of a base station. In the exemplary set 2400 of protocol stacks, the CMP protocol may be carried over a DU-DU interface protocol, using, for instance, an application protocol or API applicable to that interface. It should be noted that there is no 5G interface between DUs, and the interface protocol is a protocol specified on a hypothetical DU-DU interface in 6G.

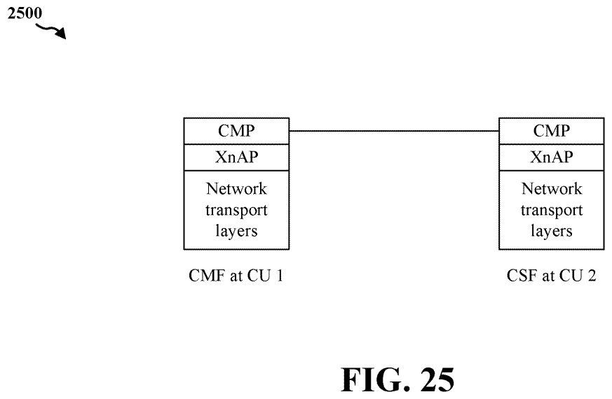

FIG. 25 illustrates an exemplary set of protocol stacks for transport of CMP between a CMF and a CSF, in which the CMF is associated with one CU of a base station and the CSF is associated with another CU of a base station. In the exemplary set 2500 of protocol stacks, the CMP protocol may be carried over XnAP, which is the application protocol for the 5G Xn interface between CUs. It should be noted that future specification may include a different protocol from the XnAP on the Xn interface between CUs, and CMP may be carried over this protocol between CUs.

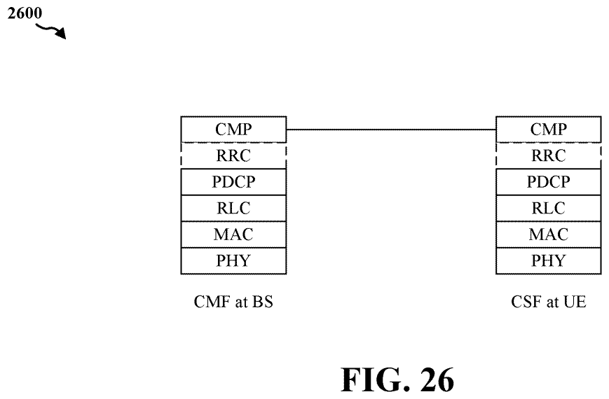

FIG. 26 illustrates an exemplary set of protocol stacks for transport of CMP between a CMF and a CSF, in which the CMF is instantiated at a base station and the CSF is hosted at a UE. In the exemplary set 2600 of protocol stacks, the CMP protocol may be carried over the air interface layers, such as the PDCP layer or the optional RRC layer. Specifically, RRC is optional in this example. The L2 sublayers shown (PDCP/RLC/MAC) are aligned with 5G, and implementation of the L2 stack may be different. It should be noted that the roles of the nodes may be switched, which applies to the case of a CMF at the UE and a CSF at the base station.

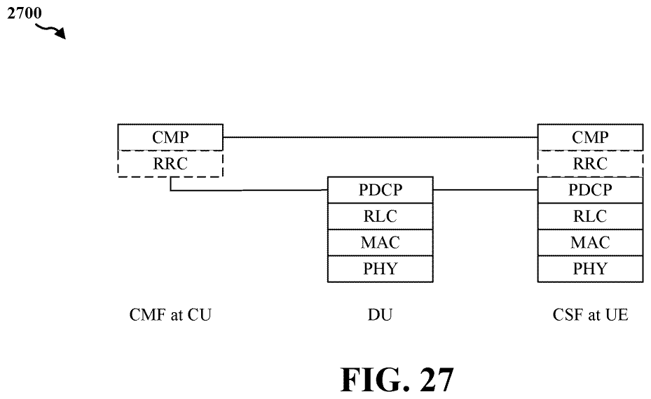

FIG. 27 illustrates an exemplary set of protocol stacks for transport of CMP between a CMF and a CSF, in which the CMF is associated with a CU of a base station and the CSF is hosted at a UE. In the exemplary set 2700 of protocol stacks, the CMP protocol may be carried over the air interface layers, such as the PDCP layer or the optional RRC layer. CMP is carried directly over a PDCP layer terminated between the CSF and the DU. The interface between the DU and the CMF may be proprietary or specified. Specifically, RRC is optional in this example. The L2 sublayers shown (PDCP/RLC/MAC) are aligned with 5G, and implementation of the L2 stack may be different. It should be noted that the roles of the nodes may be switched, which applies to the case of a CMF at the UE and a CSF at the CU.

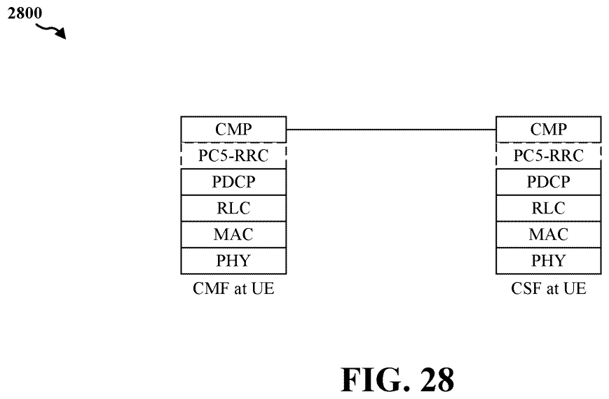

FIG. 28 illustrates an exemplary set of protocol stacks for transport of CMP between a CMF and a CSF, in which both the CMF and the CSF are hosted at two UEs. In the exemplary set 2800 of protocol stacks, the CMP protocol may be carried over the PDCP layer or the optional PC5-RRC layer. Specifically, PC5-RRC, which represents the radio resource control protocol of a direct UE-UE interface (called a PC5 interface in 5G), is optional in this example. The L2 sublayers shown (PDCP/RLC/MAC) are aligned with 5G, and implementation of the L2 stack may be different.

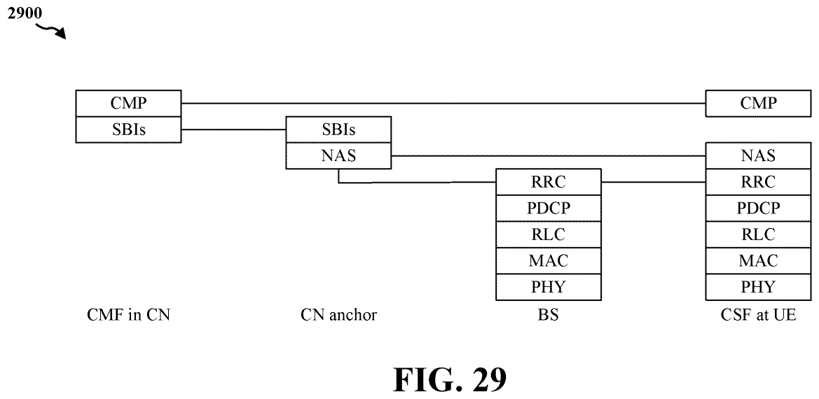

FIG. 29 illustrates an exemplary set of protocol stacks for transport of CMP between a CMF and a CSF, in which the CMF is instantiated at a CN and the CSF is hosted at a UE. In the exemplary set 2900 of protocol stacks, there is a single CN anchor (like the AMF in 5G), with which the UE communicates via a point-to-point NAS protocol, and the CN anchor communicates with other CN nodes (one of which may host the CMF). In this case, CMP may be encapsulated in a NAS message between the UE and the CN anchor, and carried over SBIs between the CN anchor and the CMF. It should be noted that the roles of the nodes may be switched, which applies to the case of a CMF at the UE and a CSF at the CN. In certain embodiments, substantially any CN node could physically host the CMF/CSF and communicate with the CSF/CMF according to the exemplary set 2900 of protocol stacks. In certain embodiments, the BS may be disaggregated into a CU and a DU.

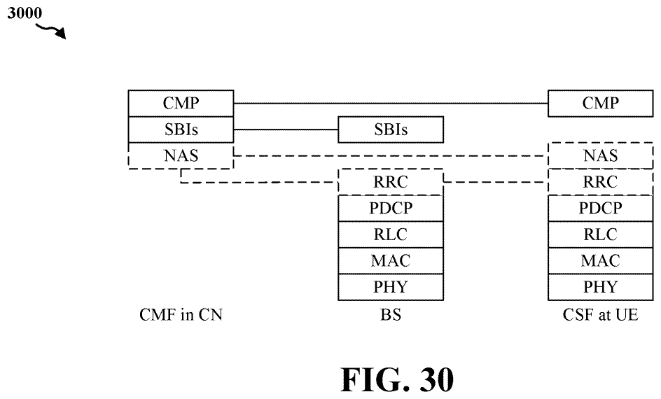

FIG. 30 illustrates an exemplary set of protocol stacks for transport of CMP between a CMF and a CSF, in which the CMF is instantiated at a CN and the CSF is hosted at a UE. In the exemplary set 3000 of protocol stacks, there is no single CN anchor and the BS has access to the service bus, i.e., communication between the BS and CN nodes is via SBIs. Specifically, the use of RRC as transport to the BS is optional. The use of a NAS protocol (which may be one of several protocols in the NAS layer) terminated between the UE and the CN node is also optional. It should be noted that the roles of the nodes may be switched, which applies to the case of a CMF at the UE and a CSF at the CN. In certain embodiments, substantially any CN node could physically host the CMF/CSF and communicate with the CSF/CMF according to the exemplary set 3000 of protocol stacks. In certain embodiments, the BS may be disaggregated into a CU and a DU.

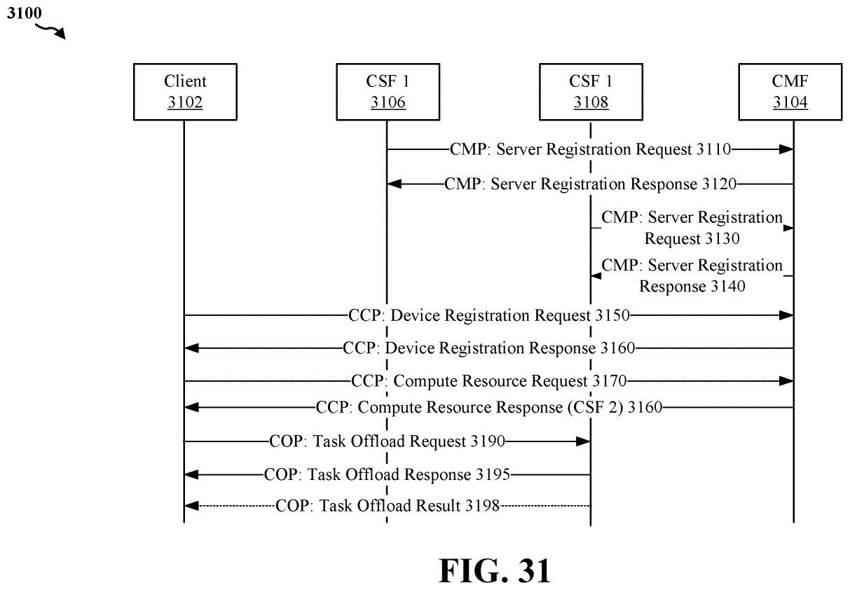

FIG. 31 illustrates an exemplary message flow for a compute session involving a client 3102, a first CSF 3106, a second CSF 3108, and a CMF 3104. Specifically, the operations 3100 as shown in FIG. 31 include four phases of operations: a first phase relying on the CMP to establish relationships between the CMF 3104 and the CSFs 3106 and 3108 (procedures 3110-3140), a second phase relying on CCP to register the client 3102 (procedures 3150 and 3160), a third phase relying on CCP to assign a CSF 3108 and resources for a compute task (procedures 3170 and 3180), and a fourth phase relying on COP to offload the compute task to the assigned CSF (procedures 3190 and 3195).

At procedure 3110, the CSF 3106 (i.e., CSF 1) sends to the CMF 3104 a server registration request of the CMP protocol. The server registration request may include, for instance, capabilities of the CSF and/or its associated server. At procedure 3120, the CMF 3104 sends to the CSF 3106 (i.e., CSF 1) a server registration response, which may, for example, confirm successful registration of the server at procedure 3310. As discussed above, the server registration response message may include additional information beyond confirming the registration, such as one or more task images. At procedures 3130 and 3140, procedures similar to the procedure 3110 and 3120 are repeated between the CMF 3104 and the CSF 3108 (i.e., CSF 2). This completes the first phase of the procedures, and the CSFs (CSF 1 and CSF 2) are now registered with the CMF 3104 and available to offer computing services.

At procedure 3150, the client 3102 sends to the CMF 3104 a device registration request (also referred to as a client registration request, as it is transmitted by the client requesting for registration) of the CCP protocol. The device registration request may include, for instance, capabilities of the client device, characteristics of an application running on the client device, a request for task images, and so on. At procedure 3160, the CMF 3104 sends to the client 3102 a device registration response (also referred to as a client registration response) of the CCP protocol, which may, for example, confirm successful registration of the client 3102 at procedure 3150. As discussed above, the device registration response message may comprise additional information beyond confirming the registration, such as one or more task images. This completes the second phase of the procedures, and the client 3102 is now registered with the CMF 3104 and prepared to request computing services for an application running on the client device.

At procedure 3170, the client 3102 sends to the CMF 3104 a compute resource request of the CCP protocol. The compute resource request may include, for instance, a compute profile of one or more requested tasks, a request for one or more task images, requested performance bounds for a computing service, and so on. procedure 3180, the CMF 3104 sends to the client 3102 a compute resource response, which in this example identifies the CSF 3108 (i.e., CSF 2) as a CSF associated with a suitable server to carry out the requested compute task(s). As discussed above, the compute resource response may include one or more identifiers for one or more selected CSFs, one or more task images, and so on. This completes the third phase of the procedures, and the client 3102 is now empowered to request task offload to CSF 2.

In certain embodiments, the client registration request at procedure 3150 and the compute resource request at procedure 3170 may be in a same message. In other words, the client 3102 may send one message including both the client registration request and the compute resource request to the CMF 3104. In response, the client registration response at procedure 3160 and the compute resource response at procedure 3180 may be in a same message. In other words, the CMF 3104 may send one message including both the client registration response and the compute resource response back to the client 3102. Alternatively, the CMF 3104 may send the client registration response and the compute resource response in separate messages back to the client 3102 in response to the same message including both the client registration request and the compute resource request.

At procedure 3190, the client 3102 sends to the CSF 3108 (i.e., CSF 2) a task offload request of the COP protocol. The task offload request may include one or more runtime images, input data for one or more requested tasks, expected performance profiles for one or more requested tasks, and so on. At procedure 3195, the CSF 3108 (i.e., CSF 2) sends to the client 3102 a task offload response. As discussed above, the task offload response may include an indication of whether one or more requested tasks are accepted, expected performance information, and so on. In some embodiments, the task offload response may be sent after execution of the task and comprise a result of executing the task (for example, output data, such as a representation of a rendered scene). In other embodiments, the task offload response may be sent upon determining whether the requested task is accepted, and in this case, at an optional procedure 3398, the CSF 3108 (i.e., CSF 2) may send to the client 3102 a task offload result of the COP protocol. As discussed above, the task offload result may result a result of executing the task (for example, output data).

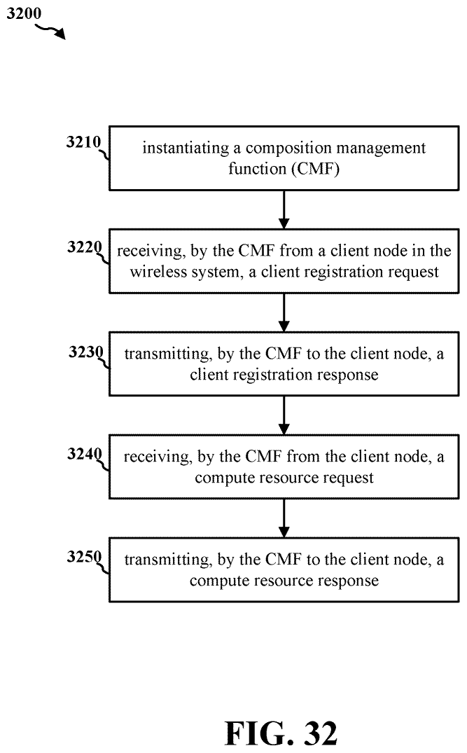

FIG. 32 is a flow chart of a method (process) for wireless communication of a device. The method may be performed by a device of a wireless system. At operation 3210, the device instantiates a CMF. At operation 3220, the device receives, by the CMF from a client node in the wireless system, a client registration request. At operation 3230, the device transmits, by the CMF to the client node, a client registration response. At operation 3240, the device receives, by the CMF from the client node, a compute resource request. At operation 3250, the device transmits, by the CMF to the client node, a compute resource response.

In certain embodiments, the device is a CU or a DU of a base station of the wireless system, and the CMF is instantiated at the CU or the DU.

In certain embodiments, the client node is a first mobile device, the device is a second mobile device, and the CMF is instantiated at the second mobile device. In one embodiment, communication between the first mobile device and the second mobile device occurs over at least one of a short-range radio interface and a wired connection.

In certain embodiments, the device is a node of an AN or a CN of the wireless system, and the CMF is instantiated at the node.

In certain embodiments, the client node is a mobile device or a network node.

In certain embodiments, the client registration response comprises policy information for controlling distribution of computational tasks from the client node.

In certain embodiments, the client registration request and the compute resource request are in a same message.

In certain embodiments, the client registration response and the compute resource response are in a same message.

In certain embodiments, each of the client registration request, the client registration response, the compute resource request, and the compute resource response is a PDU of a computing control protocol or a transaction of a computing control SBI.

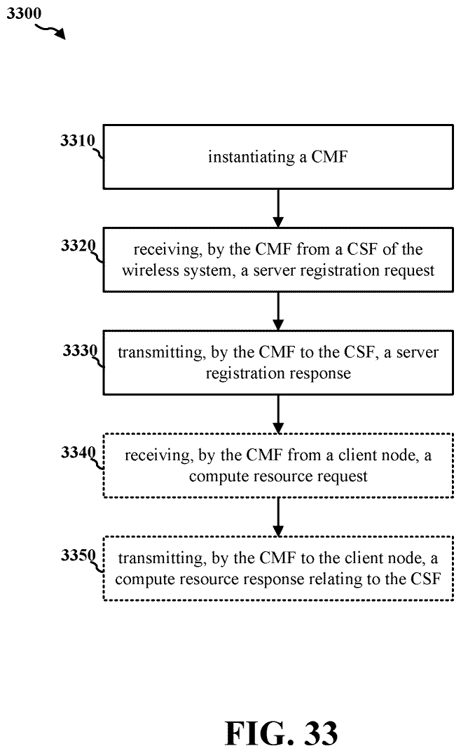

FIG. 33 is a flow chart of a method (process) for wireless communication of a device. The method may be performed by a device of a wireless system. At operation 3310, the device instantiates a CMF. At operation 3320, the device receives, by the CMF from a CSF of the wireless system, a server registration request. At operation 3330, the device transmits, by the CMF to the CSF, a server registration response. Optionally, at operation 3340, the device receives, by the CMF from a client node, a compute resource request. Optionally, at operation 3350, the device transmits, by the CMF to the client node, a compute resource response relating to the CSF.

In certain embodiments, the device is a CU or a DU of a base station of the wireless system, and the CMF is instantiated at the CU or the DU.

In certain embodiments, the device is a mobile device, and the CMF is instantiated at the mobile device.

In certain embodiments, the CSF is instantiated at a CU or a DU of a base station of the wireless system.

In certain embodiments, the CSF is instantiated at a mobile device.

In certain embodiments, each of the server registration request and the server registration response is a protocol data unit (PDU) of a computing management protocol.

In certain embodiments, the compute resource response includes information on the CSF.

In certain embodiments, the information on the CSF comprises at least an identifier of the CSF.

In certain embodiments, the compute resource request comprises information on at least one computational task.

In certain embodiments, the information comprises a compute profile of the at least one computational task.

In certain embodiments, the compute profile comprises a measure of anticipated computing load for the at least one computational task.

In certain embodiments, the compute profile comprises a latency requirement for the at least one computational task.

In certain embodiments, the device transmits, by the CMF to a client node, an indication of an availability of compute resources at a server associated with the CSF.

In certain embodiments, the indication is contained in a compute resource response of a computing control protocol.

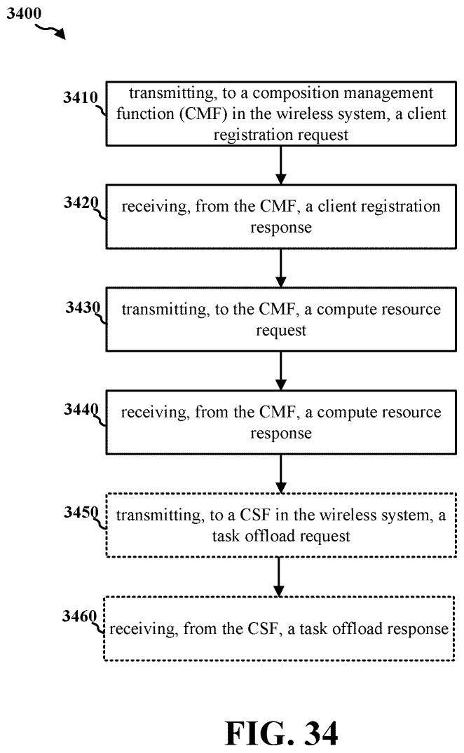

FIG. 34 is a flow chart of a method (process) for wireless communication of a client node. The method may be performed by a client node of a wireless system. At operation 3410, the client node transmits, to a composition management function (CMF) in the wireless system, a client registration request. At operation 3420, the client node receives, from the CMF, a client registration response. At operation 3430, the client node transmits, to the CMF, a compute resource request. At operation 3440, the client node receives, from the CMF, a compute resource response. Optionally, at operation 3450, the client node transmits, to a compute server function (CSF) in the wireless system, a task offload request. Optionally, at operation 3660,

In certain embodiments, the client registration request and the compute resource request are in a same message.

In certain embodiments, the client registration response and the compute resource response are in a same message.

In certain embodiments, communication with the CSF is established based at least in part on the contents of the compute resource response.

In certain embodiments, the CSF is instantiated at a CU or a DU of a base station.

In certain embodiments, the client node is a first mobile device, and the CSF is instantiated at a second mobile device.

In certain embodiments, communication between the first mobile device and the second mobile device occurs over at least one of a short-range radio interface and a wired connection.

In certain embodiments, each of the client registration request, the client registration response, the compute resource request, and the compute resource response is a PDU of a computing offload protocol or a transaction of a computing offload SBI.

In certain embodiments,

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication of a device of a wireless system, comprising:
instantiating a composition management function (CMF);
receiving, by the CMF from a client node in the wireless system, a client registration request;
transmitting, by the CMF to the client node, a client registration response;
receiving, by the CMF from the client node, a compute resource request; and
transmitting, by the CMF to the client node, a compute resource response.

2. The method of claim 1, wherein the device is a centralized unit (CU) or a distributed unit (DU) of a base station of the wireless system, and the CMF is instantiated at the CU or the DU.

3. The method of claim 1, wherein the client node is a first mobile device, the device is a second mobile device, and the CMF is instantiated at the second mobile device.

4. (canceled)

5. (canceled)

6. (canceled)

7. The method of claim 1, wherein the client registration response comprises policy information for controlling distribution of computational tasks from the client node.

8. The method of claim 1, wherein the client registration request and the compute resource request are in a same message.

9. The method of claim 1, wherein the client registration response and the compute resource response are in a same message.

10. The method of claim 1, wherein each of the client registration request, the client registration response, the compute resource request, and the compute resource response is a protocol data unit (PDU) of a computing control protocol or a transaction of a computing control service-based interface (SBI).

11. A method of wireless communication of a device of a wireless system, comprising:
instantiating a composition management function (CMF);
receiving, by the CMF from a compute server function (CSF) of the wireless system, a server registration request; and
transmitting, by the CMF to the CSF, a server registration response.

12. (canceled)

13. (canceled)

14. The method of claim 11, further comprising:
receiving, by the CMF from a client node, a compute resource request; and
transmitting, by the CMF to the client node, a compute resource response relating to the CSF.

15. (canceled)

16. (canceled)

17. (canceled)

18. (canceled)

19. (canceled)

20. The method of claim 11, wherein the compute resource request comprises information on at least one computational task.

21. (canceled)

22. (canceled)

23. (canceled)

24. The method of claim 11, further comprising:
transmitting, by the CMF to a client node, an indication of an availability of compute resources at a server associated with the CSF.

25. (canceled)

26. A method of wireless communication of a client node of a wireless system, comprising:
transmitting, to a composition management function (CMF) in the wireless system, a client registration request;
receiving, from the CMF, a client registration response;
transmitting, to the CMF, a compute resource request; and
receiving, from the CMF, a compute resource response.

27. The method of claim 26, wherein the client registration request and the compute resource request are in a same message.

28. The method of claim 26, wherein the client registration response and the compute resource response are in a same message.

29. The method of claim 26, further comprising:
transmitting, to a compute server function (CSF) in the wireless system, a task offload request; and
receiving, from the CSF, a task offload response.

30. The method of claim 29, wherein communication with the CSF is established based at least in part on the contents of the compute resource response.

31. (canceled)

32. The method of claim 29, wherein the client node is a first mobile device, and the CSF is instantiated at a second mobile device.

33. (canceled)

34. The method of claim 26, wherein each of the client registration request, the client registration response, the compute resource request, and the compute resource response is a protocol data unit (PDU) of a computing offload protocol or a transaction of a computing offload service-based interface (SBI).
